(19) United States
(12) Patent Application Publication
(10) Pub. No.: US 2003/0233378 A1
(43) Pub. Date: Dec. 18, 2003

(54) Apparatus and method for reconciling resources in a managed region of a resource management system

(75) Inventors: Walter David Butler, Plano, TX (US); Oluyemi Babatunde Saka, Austin, TX (US)

Correspondence Address: Duke W. Yee, Carstens, Yee & Cahoon, LLP, P.O. Box 802334, Dallas, TX, 75360, US

(73) Assignee: International Business Machines Corporation, Armonk, NY (US)

(21) Appl. No.: 10/171,840

(22) Filed: Jun. 13, 2002

(51) Int. Cl. G06F 17/30

(52) U.S. Cl. 707/200

(57) ABSTRACT

An apparatus and method for reconciling resources in a managed region of a resource management system. With the apparatus and method, an object database storing objects associated with resources managed by the resource management server is queried to generate a resource file. The resource file identifies the resources managed or available in the managed region of the resource management server. A resource file is also generated for a target resource management server. The differences between the two resource files are then identified and stored in a differences file. The differences file is then used to duplicate those resources that are managed by the first resource management server but are not managed by the target resource management server. In this way, the resources available through the first resource management server will also be available through the target resource management server and services may be obtained across managed region boundaries without a change in the way the service is implemented.

### BACKGROUND OF THE INVENTION

1. Technical Field

The present invention is generally directed to an improved computing system. More specifically, the present invention is directed to an apparatus and method for reconciling resources in a managed region of a resource management system.

2. Description of Related Art

The management of heterogeneous distributed computer systems is a complex task that can involve various operating systems, distributed network services and system management tasks. International Business Machines, Inc. Has created a system for centralized control of a distributed environment, which can include mainframes, UNIX or NT workstations, personal computers, and the like. This system is known as the Tivoli Management Environment of which, the Tivoli Management Framework is the base component on which Tivoli applications are built for management of distributed computing systems. Information about the Tivoli Management Environment and Tivoli Management Framework can be obtained from the Tivoli web site at http://www.tivoli.com/support/public/Prodman/public_manua1s/td/ManagementFramework3.7.1.html, for example.

The Tivoli Management Environment (TME) framework provides the foundation for managing resources in a distributed environment. The TME framework provides a set of system management services that enable a user to install both the framework and selected applications on multiple heterogeneous systems. Once installed and configured, the framework provides a robust foundation for managing TME resources, policies and policy regions.

A resource, or managed resource, as the term is used in the present application, is any hardware or software entity (machine, service, system or facility) that is represented by a database object. Managed resources are subject to a set of rules and must be a supported resource type in a policy region. Managed resources include, but are not limited to, managed nodes, task libraries (a container in which an administrator may create and store tasks and jobs), profiles (a container for application-specific information about a particular type of resource), profile managers (a container that holds profiles and that links a profile to a set of resources, called “subscribers”), monitors (a program that resides in the endpoint (workstation which has the Tivoli Management Agent program running in it), and performs the task of monitoring a resource/program—e.g. disk space, process, memory etc.), bulletin boards (a mechanism to which notices may be posted so that the framework and applications may communicate with the human administrator), workstations, software, and the like.

A policy is a set of rules that is applied to managed resources. A specific rule in a policy is referred to as a policy method. An example of a policy is that all user accounts must have passwords, and password aging must be enabled. These rules may take the form of software, shell scripts, written procedures and guidelines, and the like.

A policy region is a group of managed resources that share one or more common policies. Policy regions are used to model the management and organizational structure of a network computing environment. The policy region contains resource types and a list of resources to be managed.

The TME framework, in its most basic sense, is comprised of one or more Tivoli Management Region (TMR) servers and one or more managed nodes. A TMR server is a server that holds or references a complete set of software, including the full object database, for a Tivoli management region. A Tivoli management region is defined as a Tivoli management region server and its associated managed nodes. The TMR server includes the libraries, binaries, data files, and graphical user interfaces needed to install and manage a TME. The TMR server maintains the TMR server database and coordinates all communications with TME managed nodes. The TMR server also performs all authentication and verification necessary to ensure the security of TME data.

A TME managed node runs the same software that runs on a TMR server. Managed nodes maintain their own databases, which can be accessed by the TMR server. When managed nodes communicate directly with other managed nodes, they perform the same communication and/or security operations performed by the TMR server. The primary difference between a TMR server and a managed node is the size of the database maintained.

One configuration of a TME framework requires a two-tiered approach: TMR servers communicating with managed nodes or personal computer managed nodes. FIG. 1A illustrates such a configuration. As shown in FIG. 1A, a single TMR server 110 manages the resources of managed nodes 120-140 which also manage their own resources. Thus, the TMR server 110 will maintain a database relating to each of the managed nodes 120-140, and the managed nodes 120-140 will maintain a database relating to their own respective resources.

With such a configuration, operations on each client device, or endpoint, of each managed node 120-140 required a call to the TMR server 110 to update information on the server database. For a large installation, this communication load is substantial. Additionally, operating system imposed limits on the number of clients a system can communication with at one time limits the size of a Tivoli Managed Region (TMR) to no more than approximately 200 clients.

In another configuration, as shown in FIG. 1B, a three-tiered approach is taken. In this configuration, a TMR server 150 is coupled to gateways 160 and 170, and a managed node 180. With the reduced number of managed nodes in the TMR, the amount of communication with the TMR server is significantly reduced. Endpoints 175, or clients, do not communicate with the TMR server 150, except during the initial login process. All endpoint 175 communications go through the gateway 170. In most cases, the gateway 170 will provide all of the support an endpoint needs without requiring communication with the TMR server 150. In a smaller workgroup-size installation, the gateway 170 may be created on the TMR server 150.

The TME framework provides the ability to subdivide an enterprise network into multiple TMRs, and then to connect them with either one or two-way connections. Installations composed of managed nodes and personal computer managed nodes often require multiple TMRs for a variety of reasons. Installations using endpoints and endpoint gateways rarely need more than one TMR.

Connecting TMRs implies an initial exchange and periodic update of names and object identifiers contained in each server's name registry. For example, the names of managed nodes, profile managers, and endpoints are registered in a TMR server's name registry and should be exchanged between connected TMRs. However, not all resources recorded in the name registry are exchanged because resources that are not exchanged are specific to the particular TMR it resides on.

Therefore, a number of restrictions exist on what can be done transparently across TMR boundaries. In particular, intra-TMR management operations that involve the use of non-exchangeable resources might behave differently when those same operations are performed across TMR boundaries.

Updating resources across TMRs is a pull operation from the remote TMR to the local TMR. TMRs pull only those resource types that are managed resources within the TMR. There are occasions when a local TMR might not have the same set of resource types as the remote TMR, and operations performed on these resources will behave differently when performed across TMR boundaries. In some cases, it might not be possible to perform the operation remotely at all. Because updates must be explicitly requested, resources created in a remote TMR might not be available for use in a local TMR until the next time those resource names are updated. It is important to remember that resources and resource types are created by both the TME framework and the applications supplied by Tivoli and third party vendors. Therefore, both the TME framework and the applications have sets of resources that must be exchanged if they are to work across TMRs. Also, every application may have specific resource names that are not exchanged, i.e. names of resources that are specific to the TMR and cannot be exchanged, and thus, might exhibit different behavior when “crossing” a TMR boundary. That is, since TMRs can be connected to each other, resources can be shared between these connected TMRs. However, it is the case that there may exist one or more resources that cannot be shared between the connected TMRs. Thus, such a resource cannot cross the TMR boundary in which it resides so as to be shared with another TMR.

Suppose, for example, an organization installs TMR User Administration for user and group management, but only installs it in one TMR. The TME User Administration adds a resource class called UserProfile, which maintains a list of all user names in the TMR. Using validation policy, the organization can require unique user names. Each time a user is added in the TMR, the TME checks the name registry to ensure the name does not already exist.

The UserNameDB resource cannot be exchanged across connected TMRs. Therefore, the organization can require unique names within a TMR but cannot enforce unique user names across connected TMRs. When the user is added, TME checks the name registry of the local server. This registry does not contain a list of user names from a remote server. Thus, it would be beneficial to have an apparatus and method that allows for reconciliation of TMR resources across TMR boundaries.

### SUMMARY OF THE INVENTION

The present invention provides an apparatus and method for reconciling resources in a managed region of a resource management system. With the apparatus and method of the present invention, an object database storing objects associated with resources managed by the resource management server is queried to generate a resource file. The resource file identifies the resources managed or available in the managed region of the resource management server. A resource file is also generated for a target resource management server.

The differences between the two resource files are then identified and stored in a differences file. The differences file is then used to duplicate those resources that are managed by the first resource management server but are not managed by the target resource management server. In this way, the resources available through the first resource management server will also be available through the target resource management server and services may be obtained across managed region boundaries without a change in the way the service is implemented.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A is an exemplary block diagram of a resource management system according to a first type;

FIG. 1B is an exemplary block diagram of a resource management system according to a second type;

FIG. 2 is an exemplary block diagram of a distributed computing system in which the present invention may be implemented;

FIG. 3 is an exemplary block diagram of a resource management server in accordance with the present invention;

FIG. 4 is an exemplary block diagram of a resource reconciliation service provider according to one embodiment of the present invention;

FIG. 5A is an exemplary diagram of a resource file in accordance with the present invention;

FIG. 5B is an exemplary diagram of a differences file in accordance with the present invention; and

FIG. 6 is a flowchart outlining an exemplary operation of the present invention.

### DETAILED DESCRIPTION OF THE PREFERRED EMBODIMENT

The present invention provides an apparatus and method for reconciling resources in a managed region of a resource management system. The present invention may be implemented in any distributed computing system in which resource management servers are utilized to manage resources for a managed region of the distributed computing environment. In a preferred embodiment, the present invention is implemented in a Tivoli Management Environment in which a Tivoli framework is utilized upon which Tivoli applications are run. With such a Tivoli Management Environment may be comprised of two or more Tivoli Managed Regions (TMRs) comprised of a TMR server, or resource management server, and one or more managed nodes.

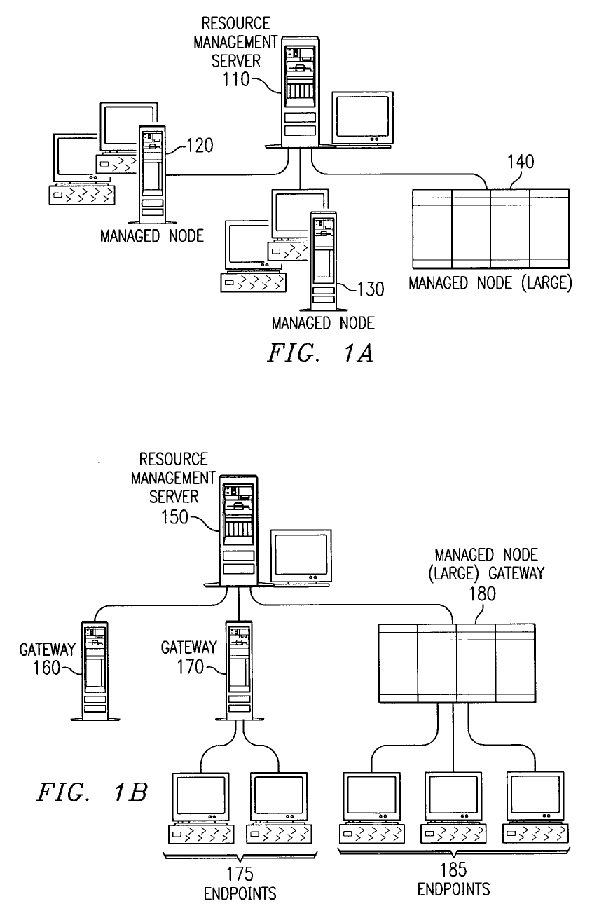

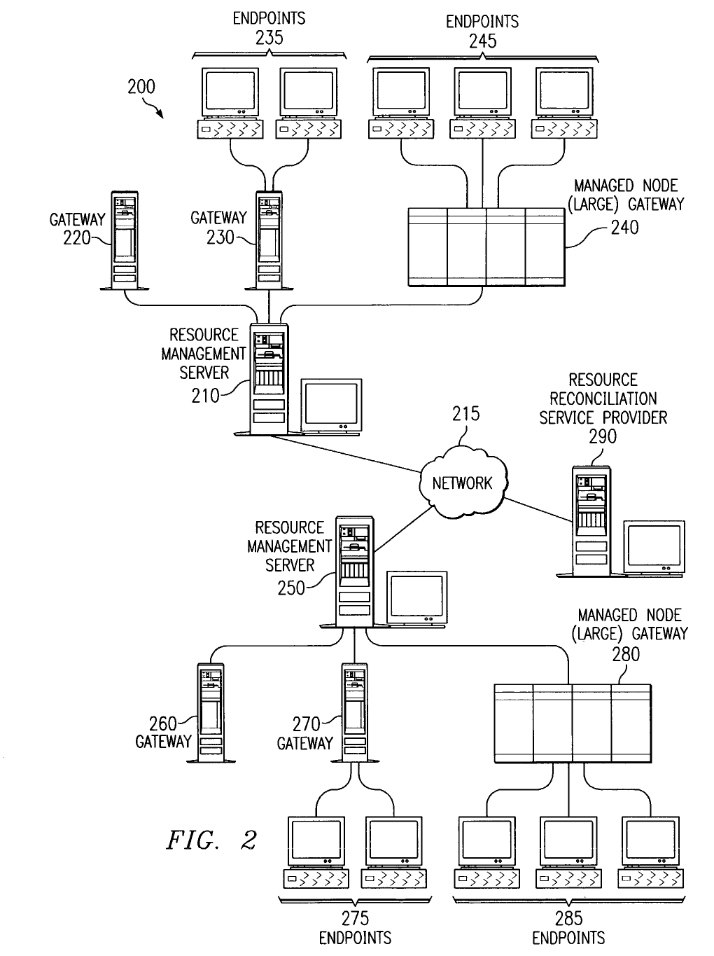

The present invention, according to the preferred embodiment, may be used with TMRs of either type shown in FIGS. 1A and 1B. In a preferred embodiment, however, the TMRs take the form shown in FIG. 1B since this configuration minimizes the amount of communication between the endpoints and the resource management server.

FIG. 2 is an exemplary diagram of a distributed computing system 200 in accordance with the present invention. As shown in FIG. 2, the distributed computing system includes a first resource management server 210 coupled to another resource management server 250 via a network 215, which is the medium used to provide communications links between various devices and computers connected together within the distributed computing system 200. Network 215 may include connections, such as wire, wireless communication links, fiber optic cables, and the like.

In the depicted example, the resource management servers 210 and 250 manage resources on gateways 220-230, 260-270 and managed nodes 240 and 280. Clients, or endpoints, 235, 245, 275 and 285 operate via the gateways or managed nodes, respectively. The distributed computing system 200 may include additional servers, clients, and other devices not shown. The endpoints may be personal computers, workstations, printers, scanners, storage devices, or any other device capable of communication with the gateways or managed nodes.

In the depicted example, the network 215 may be the Internet with network 215 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages.

Of course, distributed computing system 200 also may be implemented as a number of different types of networks, such as for example, an intranet, a local area network (LAN), a wide area network (WAN), or the like. FIG. 2 is intended as an example, and not as an architectural limitation for the present invention.

In addition to the above elements, the distributed computing system 200 includes a resource reconciliation service provider 290. The resource reconciliation service provider 290 performs the functions of the present invention with regard to generating resource files for resource management servers, identifying differences between the resource files, and reconciling those differences by replicating those elements that are different to the resource management servers that need them. These functions will be discussed in detail hereafter.

While FIG. 2 illustrates the functions of the present invention being implemented in a dedicated service provider 290, the present invention is not limited to such. Rather, the resource reconciliation processes of the present invention may be performed on the resource management servers 210 and 250 such that reconciliation is performed in favor of a local resource management server. For example, the resource reconciliation may be performed on the resource management server 210 so that resources available in the managed region of resource management server 250 are compared against the resources available in the managed region of resource management server 210. Resources available in the managed region of resource management server 250 that are not available in the managed region of resource management server 210 may then be duplicated on the resource management server 210. This same function can be performed on resource management server 250 with favor being given to local resource management server 250. In an alternative embodiment, the functions of the present invention may be distributed over two or more resource management servers.

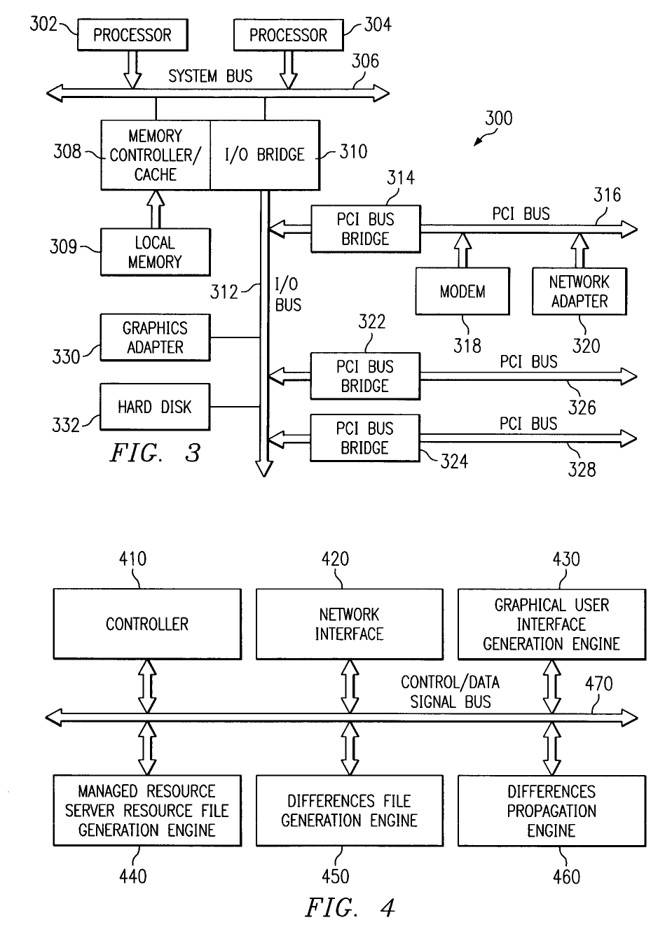

Referring to FIG. 3, a block diagram of a data processing system that may be implemented as a server, such as server 210 or 250 in FIG. 3, is depicted in accordance with a preferred embodiment of the present invention. Data processing system 300 may be a symmetric multiprocessor (SMP) system including a plurality of processors 302 and 304 connected to system bus 306. Alternatively, a single processor system may be employed. Also connected to system bus 306 is memory controller/cache 308, which provides an interface to local memory 309. I/O bus bridge 310 is connected to system bus 306 and provides an interface to I/O bus 312. Memory controller/cache 308 and I/O bus bridge 310 may be integrated as depicted.

Peripheral component interconnect (PCI) bus bridge 314 connected to I/O bus 312 provides an interface to PCI local bus 316. A number of modems may be connected to PCI local bus 316. Typical PCI bus implementations will support four PCI expansion slots or add-in connectors. Communications links to managed nodes and gateways in FIG. 2 may be provided through network adapter 320 connected to PCI local bus 316 through add-in boards. Additional PCI bus bridges 322 and 324 provide interfaces for additional PCI local buses 326 and 328, from which additional network adapters may be supported. In this manner, data processing system 300 allows connections to multiple network computers and devices. A memory-mapped graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

As discussed previously the present invention provides a mechanism for reconciling resources between managed regions, and in particular, the resource management servers of the managed regions. With the present invention, four basic functions are performed: exporting of resources to a resource file, generating differences between the resource files of two or more resource management servers, reconciliation of the differences between the resource files, and outputting a tree-view of all files generated during the reconciliation process.

The process of reconciling resources between two managed regions is started when a command or event occurs requiring such reconciliation. The command may be input, for example, by an administrator or the like, via a terminal or other computing device that is linked to the resource reconciliation service provider 290. Such linking may be via the network 215, for example, or other direct or indirect communication connection to the resource reconciliation service provider 290. Such a command may be subjected to authentication of the administrator submitting the command or may be input after a login process, for example.

Alternatively, the reconciliation of resources may be instigated automatically in response to the occurrence of an event. For example, such reconciliation may be performed on at predetermined times, on a particular time interval, in response to a change in the resources being managed, and the like.

Once the command is received, or the event occurs, the first step in the resource reconciliation process is to export the resources of the resource management servers that are the subject of the reconciliation. In the following examples, the resource reconciliation will be described with regard to only two resource management servers for purposes of clarity. However, the principles and processes of the present invention may be utilized with two or more resource management servers without departing from the spirit and scope of the present invention.

Exporting resources to a resource file involves performing a query of each object database on the resource management servers 210 and 250 for information regarding the resources managed by the resource management servers 210 and 250. In the distributed computing system 200 of FIG. 2, resources are represented in the resource management servers 210 and 250 as objects and the object database is used to keep track of and access these objects. Thus, by querying the object database for information regarding the objects therein, information about the resources managed by the resource management server may be obtained. In the preferred embodiment, such information includes the content of the profile managers, endpoint subscribers, policy regions, profiles, monitors, monitor contents and configurations, and the like.

The information obtained from the object database is stored in a resource file for the resource management server. This is done for each resource management server involved in the resource reconciliation.

With one exemplary embodiment of the present invention, the reconciliation is performed using a reconciliation script. When the reconciliation script is executed, an interactive menu is launched which prompts the user to insert the operation intended to be performed. (Generate Resource or Difference between existing resource files). The Get_Cmdline_Args ( ) subroutine is called and iterates through the command-line argument grabbing and processing all arguments succeeding a “-”. This subroutine gets the filename specified at the command line if and only if the preceding switch is a “-e”. The filename is retrieved and parsed and then passed to this routine for creating.

In order to get all the resources, the Tivoli Object database is queried within a “foreach” statement thus grabbing each and every resource associated with that TMR. When this is accomplished, the following routine listed below is responsible for printing all retrieved resources to the resource file.

Name: ResFile_WriteFile ( )

Abstract: Prints the resources processed to the resource file (output)

Inputs: Takes output information from the resource Functions

Outputs: Prints output to the resource file and prints progress to STDOUT so the user will know something's happening.

Tivoli commands are used to actually extract the resource information from the Tivoli Object database. Table 1 below illustrates some of the commands that are used by the present invention and what their corresponding functions are. The Tivoli code behind these commands perform the actual query of the object database.

TABLE 1
Tivoli Commands for Accessing Tivoli
Object Database

| Commands | Usage |
|---|---|
| Wls/wcd | Used to list a collection's members |
| | objects and change current working |
| | collection |
| wlsmon | Used to retrieve information on DM |
| | monitors and their configurations |
| wgetsub | Used to get subscribers that belong to a |
| | ProfileManager |
| wlookup | Used to search for resource listings in |
| | the Tivoli Named Registry |
| Idlcall, | Idlcall-Provides a method for invoking |
| idlattr | interface definition language from the |
| objcall | command line interface. |
| | Idlattr-This command gets or sets |
| | implementation (object) attributes. |
| | Objcall-This command performs an object |
| | call from the shell. |
| Wtmrname | Used to retrieve the local Tivoli managed |
| | region (TMR) |

In one exemplary embodiment of the present invention, the resource file that is generated by the reconciliation script is a file that contains all Tivoli resources specific to the following:

TMR Name

Profile Manager

ProfileManager Name

ProfileManager Subscribers

ProfileManager PolicyRegion

Profile(s)

Profile Monitors

Monitor Configuration(s)

The information in the resource files may be formatted by the reconciliation script and listed in categories in order to make it easier to perform the comparison of the resource files to generate differences, as discussed hereafter.

Once the resource files for the resource management servers are generated, the differences between the resource files are identified. To identify the differences between the two resource files, a comparison of the resource files is performed.

Such a comparison may take the form of a simple text comparison that identifies any discrepancies between text in the two resource files. Alternatively, a more complex mechanism in which resource categories are identified, based on resource labels or tags in the resource file, for example, and their respective values compared to determine if they match or there is a difference. This alternative comparison mechanism is preferred over a simple text comparison since the text comparison is over-inclusive when it comes to identifying differences in two resource files.

In one exemplary embodiment of the present invention, the differences between the resource files is generated using the reconciliation script with the menu selection for generating differences selected. In response to this menu selection, the Get_Cmdline_Args ( ) subroutine is called and iterates through the command-line argument grabbing and processing all arguments succeeding a “-”. If the “-d” switch is indicated, as with the selection of the generate differences option from the menu, the difference engine is invoked. The difference engine checks to see if both files supplied at the command line exist. If one or both files do not exist, then an appropriate error message is output. If both files do exist, then the differencing engine proceeds with further processing. A UNIX difference command is used to run a difference on both files. If there are any differences, then they are written out to the file that stores the difference in both TMRs.

Each line in both files are compared string by string in order to detect the slightest difference. If any is detected, it will be recorded in the difference file. The following is an outline of the difference engine:

Name: DifferenceEngine ( )

Abstract: This routine uses the two files retrieved from the command line and runs the unix_diff_command in order to spaws differences between both files. The difference are written to a temporary file which parsed and rewritten to a more human readable and further parsable file.

Inputs: Gets input from the files supplied at the command line.

$ fname1 (Resource file on TMR A)

$ fname2 (Resource file from TMR B)

Outputs: Outputs differences to the TMRresource.dif file

Once the differences are identified, these differences are stored in a differences file for use in performing the actual reconciliation of these differences. The differences file may identify both the resource available on the first resource management server and the resource available on the second resource management server, if both exist, that are different. Thus, for example, if resource management server 210 has a profile resource “iProcess 1FakeSentryPRF2” and the resource management server 250 has a profile “Process FakeSentryPRF2,” the differences file will identify both of these resources and the resource management server to which they correspond. Thus, the differences file may be used to reconcile resources on both or either one of the resource management servers.

Alternatively, if the reconciliation is being performed in favor of one of the resource management servers, e.g., the local resource management server, the differences file may contain only the identifiers of the resources present on the remote resource management server, i.e. the resource management server that is not favored. As a result, the differences file will be used only to reconcile the resources on the local, or favored, resource management server.

After having generated the differences file, reconciliation of the differences is performed. Reconciliation requires the duplication of the resources from the resource management server having the resources to the resource management server that does not have the resources. The duplication involves creation of the resource objects in the object database of the resource management server. Such creation may involve a copying of objects from the resource management server having the resources or local creation of the object in the object database of the resource management server based on the information obtained from the differences file and/or further information requested from the resource management server having the resource.

Once the objects are created in the object database of the resource management server, the resource management server, its clients, and the like, may access those resources as if the resources were local to the resource management server. Thus, operations may be performed over managed region boundaries without hindrance.

Furthermore, the present invention may generate a graphical representation illustrating the reconciliation operations performed. In other words, a graphical representation of the files, objects, and the like, identified and generated during the reconciliation operation, along with their locations, may be presented for use by a human user. Such a graphical representation may take the form of a tree structure, for example, illustrating the hierarchical relationship of the files and objects involved in the reconciliation.

Thus, the present invention provides a mechanism for reconciling resources across managed region boundaries in a resource management distributed computing system. With the present invention, discrepancies between the resources available to resource management servers may be identified and eliminated through reconciliation of these discrepancies such that the resources are available to each of the resource management servers involved in the reconciliation.

FIG. 4 is an exemplary block diagram illustrating a resource reconciliation service provider in accordance with the present invention. The resource reconciliation service provider shown in FIG. 4 may be implemented as a dedicated device or may be integrated into one or more of the resource management servers in FIG. 2.

Furthermore, the elements of the resource reconciliation service provider of FIG. 4 may be implemented in hardware, software, or any combination of hardware and software. In a preferred embodiment, the elements of FIG. 4 are implemented as software scripts that are executed using one or more processing devices, storage devices, and the like.

As shown in FIG. 4, the resource reconciliation service provider includes a controller 410, a network interface 420, a graphical user interface generation engine 430, a resource file generation engine 440, a differences file generation engine 450, and a differences reconciliation engine 460. The elements 410-460 are in communication with one another via the control/data signal bus 470 which facilitates the sending and routing of control and data signals to the elements 410-460. While a bus architecture is shown in FIG. 4, the present invention is not limited to such and any architecture that facilitates the communication between elements 410-460 may be used without departing from the spirit and scope of the present invention.

The controller 410 controls the overall operation of the resource reconciliation service provider and orchestrates the operation of the other elements 420-460. The controller 410 receives and sends data from and to external devices via the network interface 420.

The graphical user interface generation engine 430 generates one or more user interfaces through which a user may request a reconciliation of resources, receive output identifying the results of the reconciliation, and the like. Such user interfaces may take the form of menu driven interfaces, graphical representations having graphical buttons or the like through which a user may enter commands, command line interfaces, and the like. In a preferred embodiment, the user interfaces may take the form of one or more web pages having fields for entry of commands and/or graphical, user manipulated, elements, such as virtual buttons, for obtaining user input.

The resource file generation engine 440 performs the functions described previously with regard to querying the object databases of the resource management servers to obtain resource information which is then stored in a resource file. The resource file generation engine 440 queries the object databases via the network interface 420 and stores the resource files in a storage device (not shown). The resource file generation engine 440 may, for example, invoke a script, application, applet, or the like, to initiate process tasking that queries the object databases and generates the resource files.

The differences file generation engine 450 performs the functions described previously for identifying the differences between the resource files generated by the resource file generation engine 440. Such functionality includes comparing the two or more resource files to identify differences and store those differences in a difference file in the storage device (not shown). The differences file generation engine 450 may, for example, invoke a script, application, applet, or the like, to initiate process tasking that generates the differences between the resource management servers.

The differences reconciliation engine 460 performs the functions described previously with regard to copying or creating objects in the object database(s) of the resource management server(s) to cause the resource management servers to no longer have differences in the available resources. The differences reconciliation engine 460 may, for example, use FTP transfers or the like, to copy objects and/or files from a source resource management server to a target resource management server.

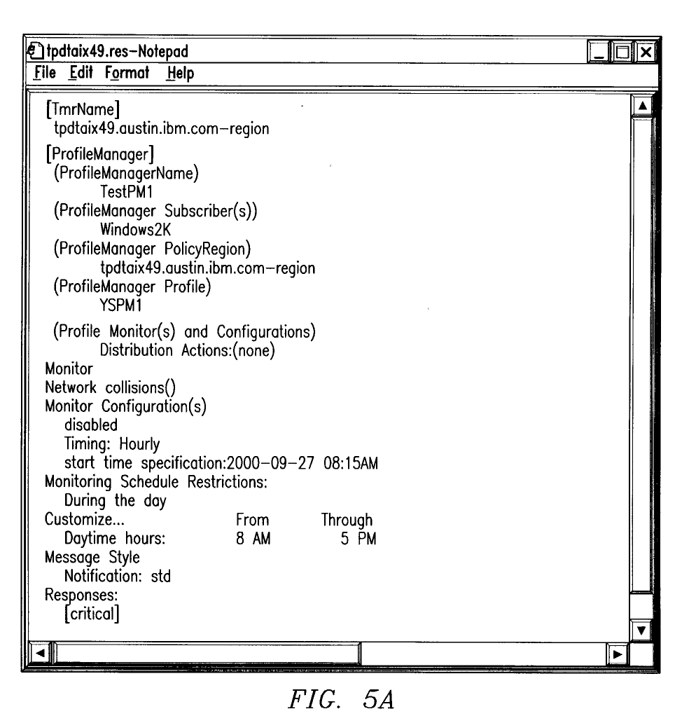

As mentioned previously, the present invention involves generating resource files identifying the resources on each of the resource management servers involved in the reconciliation and determining differences between these resource files. FIG. 5A is an exemplary diagram illustrating a resource file according to one exemplary embodiment of the present invention. As shown in FIG. 5A, the resource file includes a section for profile manager resource information 510 and profile monitor information 520. The profile manager resource information section 510 includes information such as the profile manager name, profile manager subscribers, profile manager policy region and profile manager profiles. The profile monitor information section 520 includes information regarding the monitor configurations, monitor schedule restrictions, message style, and the like.

FIG. 5B is an exemplary diagram illustrating a differences file in accordance with one exemplary embodiment of the present invention. As shown in FIG. 5B, the differences file essentially consists of designations of pairs of resources. Each pair consists one resource on each of the resource management server that correspond to one another but are different. In the depicted example, the resource management servers are “tpdtaix12.res” and “tdptaix49.res.” The identifiers after the designation of the resource management server identify the resources on that resource management server that are different from the corresponding resource on the other resource management server.

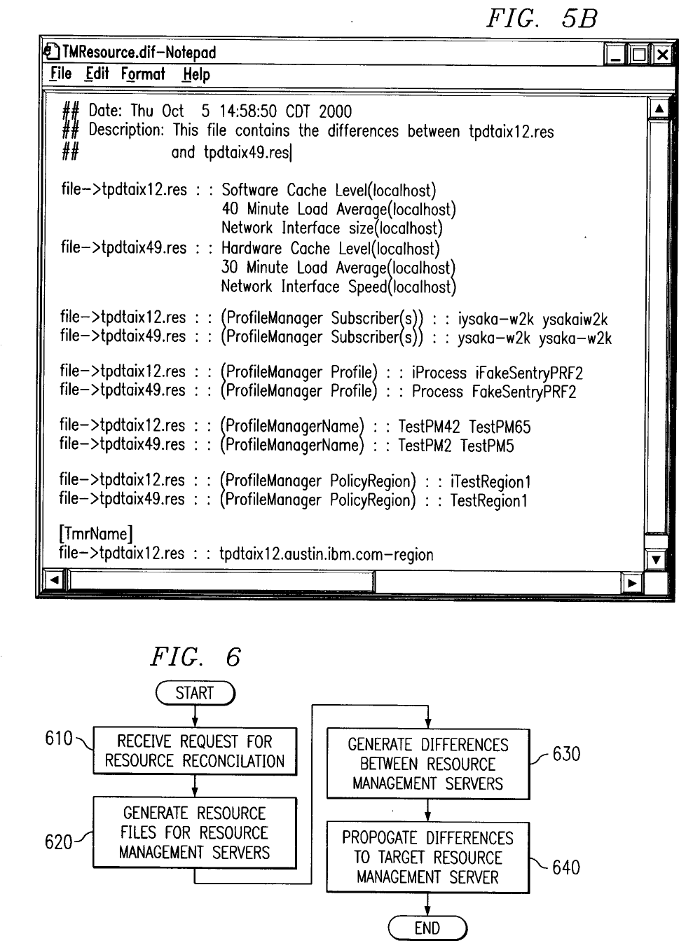

FIG. 6 is a flowchart outlining an exemplary operation of the present invention. As shown in FIG. 6, the operation starts with receiving a request for resource reconciliation (step 610). Thereafter, the resource files for the resource management servers are generated (step 620). The differences between the resource files are then identified and stored in a differences file (step 630). The differences are then reconciled between the two resource management servers (step 640) and the operation ends.

Thus, the present invention provides an apparatus and method for reconciling resources in a managed region of a resource management system. With the present invention, differences between two linked resource management servers may be automatically reconciled by identifying the resources managed by each of them and eliminating any discrepancies by creating resources or copying resources from one resource management server to the other.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of reconciling resources in a distributed computing environment, comprising:
identifying a first set of resources associated with a first resource management server;
identifying a second set of resources associated with a second resource management server;
determining differences between the first set of resources and the second set of resources; and
reconciling resources present in the first set of resources and not present in the second set of resources, with the second resource management server.

2. The method of claim 1, wherein the method is initiated by one of a user and an event.

3. The method of claim 1, wherein identifying the first set of resources includes querying a first object database associated with the first resource management server for information pertaining to the resources managed by the first resource management server, and wherein identifying the second set of resources includes querying a second object database associated with the second resource management server for information pertaining to the resources managed by the second resource management server.

4. The method of claim 1, further comprising:
generating a first resources file based on the first set of resources; and
generating a second resources file based on the second set of resources, wherein determining differences includes comparing the first resources file to the second resources file.

5. The method of claim 4, wherein the first resources file and the second resources file include at least one of a TMR Name, a ProfileManager Name, one or more identifiers of ProfileManager Subscribers, an identifier of a ProfileManager PolicyRegion, identifiers of one or more profiles, identifiers of one or more profile monitors, and identifiers of one or more profile monitor configurations.

6. The method of claim 4, wherein comparing the first resources file to the second resources file includes:
using a Unix differences command on the first and second resources files; and
writing differences to a differences file.

7. The method of claim 4, wherein comparing the first resources file to the second resources file includes:
identifying resource categories in the first and second resource files; and
comparing values in the first resources file to values in the second resources file for corresponding ones of the identified resource categories.

8. The method of claim 1, wherein reconciling resources includes duplicating resources found in the first set of resources and not in the second set of resources, in the second set of resources.

9. The method of claim 8, wherein reconciling resources further includes duplicating resources found in the second set of resources and not in the first set of resources, in the first set of resources.

10. The method of claim 8, wherein duplicating resources includes generating objects for the resources in an object database associated with the second resource management server.

11. A computer program product in a computer readable medium for reconciling resources in a distributed computing environment, comprising:
first instructions for identifying a first set of resources associated with a first resource management server;
Second instructions for identifying a second set of resources associated with a second resource management server;
third instructions for determining differences between the first set of resources and the second set of resources; and
fourth instructions for reconciling resources present in the first set of resources and not present in the second set of resources, with the second resource management server.

12. The computer program product of claim 11, wherein the first, second, third and fourth instructions are executed in response to an initiation by one of a user and an event.

13. The computer program product of claim 11, wherein the first instructions for identifying the first set of resources include instructions for querying a first object database associated with the first resource management server for information pertaining to the resources managed by the first resource management server, and wherein the second instructions for identifying the second set of resources include instructions for querying a second object database associated with the second resource management server for information pertaining to the resources managed by the second resource management server.

14. The computer program product of claim 11, further comprising:
fifth instructions for generating a first resources file based on the first set of resources; and
sixth instructions for generating a second resources file based on the second set of resources, wherein the third instructions for determining differences include instructions for comparing the first resources file to the second resources file.

15. The computer program product of claim 14, wherein the first resources file and the second resources file include at least one of a TMR Name, a ProfileManager Name, one or more identifiers of ProfileManager Subscribers, an identifier of a ProfileManager PolicyRegion, identifiers of one or more profiles, identifiers of one or more profile monitors, and identifiers of one or more profile monitor configurations.

16. The computer program product of claim 14, wherein the instructions for comparing the first resources file to the second resources file include:
instructions for using a Unix differences command on the first and second resources files; and
instructions for writing differences to a differences file.

17. The computer program product of claim 14, wherein the instructions for comparing the first resources file to the second resources file include:
instructions for identifying resource categories in the first and second resource files; and
instructions for comparing values in the first resources file to values in the second resources file for corresponding ones of the identified resource categories.

18. The computer program product of claim 11, wherein the fourth instructions for reconciling resources include instructions for duplicating resources found in the first set of resources and not in the second set of resources, in the second set of resources.

19. The computer program product of claim 18, wherein the fourth instructions for reconciling resources further include instructions for duplicating resources found in the second set of resources and not in the first set of resources, in the first set of resources.

20. The computer program product of claim 18, wherein the instructions for duplicating resources include instructions for generating objects for the resources in an object database associated with the second resource management server.

21. An apparatus for reconciling resources in a distributed computing environment, comprising:
means for identifying a first set of resources associated with a first resource management server;
means for identifying a second set of resources associated with a second resource management server;
means for determining differences between the first set of resources and the second set of resources; and
means for reconciling resources present in the first set of resources and not present in the second set of resources, with the second resource management server.

22. The apparatus of claim 21, wherein the apparatus operates in response to an initiation by one of a user and an event.

23. The apparatus of claim 21, wherein the means for identifying the first set of resources includes means for querying a first object database associated with the first resource management server for information pertaining to the resources managed by the first resource management server, and wherein the means for identifying the second set of resources includes means for querying a second object database associated with the second resource management server for information pertaining to the resources managed by the second resource management server.

24. The apparatus of claim 21, further comprising:
means for generating a first resources file based on the first set of resources; and
means for generating a second resources file based on the second set of resources, wherein the means for determining differences includes means for comparing the first resources file to the second resources file.

25. The apparatus of claim 24, wherein the first resources file and the second resources file include at least one of a TMR Name, a ProfileManager Name, one or more identifiers of ProfileManager Subscribers, an identifier of a ProfileManager PolicyRegion, identifiers of one or more profiles, identifiers of one or more profile monitors, and identifiers of one or more profile monitor configurations.

26. The apparatus of claim 24, wherein the means for comparing the first resources file to the second resources file includes:
means for using a Unix differences command on the first and second resources files; and
means for writing differences to a differences file.

27. The apparatus of claim 24, wherein the means for comparing the first resources file to the second resources file includes:
means for identifying resource categories in the first and second resource files; and
means for comparing values in the first resources file to values in the second resources file for corresponding ones of the identified resource categories.

28. The apparatus of claim 21, wherein the means for reconciling resources includes means for duplicating resources found in the first set of resources and not in the second set of resources, in the second set of resources.

29. The apparatus of claim 28, wherein the means for reconciling resources further includes means for duplicating resources found in the second set of resources and not in the first set of resources, in the first set of resources.

30. The apparatus of claim 28, wherein the means for duplicating resources includes means for generating objects for the resources in an object database associated with the second resource management server.
